(19) United States
(12) Patent Application Publication
(10) Pub. No.: US 2026/0037167 A1
(43) Pub. Date: Feb. 5, 2026

(54) QUALITY OF SERVICE ENHANCEMENT THROUGH DYNAMIC HOST MEMORY BUFFER CONFIGURATION

(71) Applicant: Micron Technology, Inc., Boise, ID (US)

(72) Inventors: Nitul Gohain, Bangalore (IN); John E. Maroney, Irvine, CA (US)

(21) Appl. No.: 19/281,312

(22) Filed: Jul. 25, 2025

Related U.S. Application Data
(60) Provisional application No. 63/679,516, filed on Aug. 5, 2024.

(51) Int. Cl. G06F 3/06

(52) U.S. Cl. CPC G06F 3/0631; G06F 3/0611; G06F 3/0673

(57) ABSTRACT

Methods, systems, and devices for dynamic allocation of a host memory buffer are described. A host system may allocate a portion of memory of the host system to a buffer for use by a memory system. In some cases, the allocation of the memory of the host system may be based on a setting indicated by the memory system, which may indicate one or more parameters associated with the buffer. The memory system may use the buffer for one or more operations, such as read, write, or system operations. In some examples, the host system may indicate one or more resources available at the host system for allocating to the buffer. The memory system may communicate a second setting including updated parameters associated with the buffer based on the indication of available resources, and the host system may allocate one or more additional resources in response to the updated parameters.

### CROSS REFERENCE

The present application for patent claims priority to U.S. Patent Application No. 63/679,516 by Gohain et al., entitled “QUALITY OF SERVICE ENHANCEMENT THROUGH DYNAMIC HOST MEMORY BUFFER CONFIGURATION,” filed Aug. 5, 2024, which is assigned to the assignee hereof, and which is expressly incorporated by reference in its entirety herein.

### TECHNICAL FIELD

The following relates to one or more systems for memory, including dynamic allocation of a host memory buffer.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports dynamic allocation of a host memory buffer in accordance with examples as disclosed herein.

FIG. 2 shows an example of a system that supports dynamic allocation of a host memory buffer in accordance with examples as disclosed herein.

FIG. 3 shows an example of a process flow that supports dynamic allocation of a host memory buffer in accordance with examples as disclosed herein.

FIG. 4 shows a block diagram of a memory system that supports dynamic allocation of a host memory buffer in accordance with examples as disclosed herein.

FIG. 5 shows a block diagram of a host system that supports dynamic allocation of a host memory buffer in accordance with examples as disclosed herein.

FIGS. 6 and 7 show flowcharts illustrating a method or methods that support dynamic allocation of a host memory buffer in accordance with examples as disclosed herein.

### DETAILED DESCRIPTION

Some memory systems may have limited memory capacity for performing system operations, such as garbage collection. For example, a memory system may include a buffer, which may be used to temporarily store data during some types of operations. In some cases, the buffer may reach capacity, and the memory system may not be able to free up space in the buffer to continue performing operations. As such, the memory system may incur latencies for some operations if the memory system is unable to perform system operations (e.g., maintenance operations). In some cases, a portion of a memory of a host device may be allocated as a buffer for use by the memory system. However, the size of the buffer may be inflexible, and may be unable to accommodate an increase in a frequency of system operations performed by the memory system (e.g., in end-of-life scenarios).

In accordance with examples described herein, a host system (e.g., a host system of an automotive platform) may allocate a portion of a memory of the host system to a buffer for use by a memory system. In some cases, the allocation of the memory of the host system may be based on a setting indicated by the memory system, which may indicate one or more parameters associated with the buffer. The memory system may use the buffer for one or more operations, such as read, write, or system operations. In some examples, the host system may indicate one or more resources available at the host system for allocating to the buffer. The memory system may communicate a second setting including one or more updated parameters associated with the buffer based on the indication of available resources, and the host system may allocate one or more additional resources in response to the updated parameters. Accordingly, the memory system and the host system may adjust a size of the buffer, which may increase the memory availability to the memory system, and may result in reduced latencies.

In addition to applicability in memory systems as described herein, techniques for dynamic allocation of a host memory buffer may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving available memory for memory systems to perform system operations, which may result in reduced latencies during end-of-life scenarios where memory systems may perform maintenance operations in increased quantities, thereby extending the life of electronic devices, among other benefits. Additionally, the memory system may be implemented within an automotive system (e.g., an automotive solid-state drive (SSD)), and may thereby support high-performance operations by the automotive system for an extended life.

Features of the disclosure are illustrated and described in the context of systems, devices, and circuits. Features of the disclosure are further illustrated and described in the context of process flows and flowcharts.

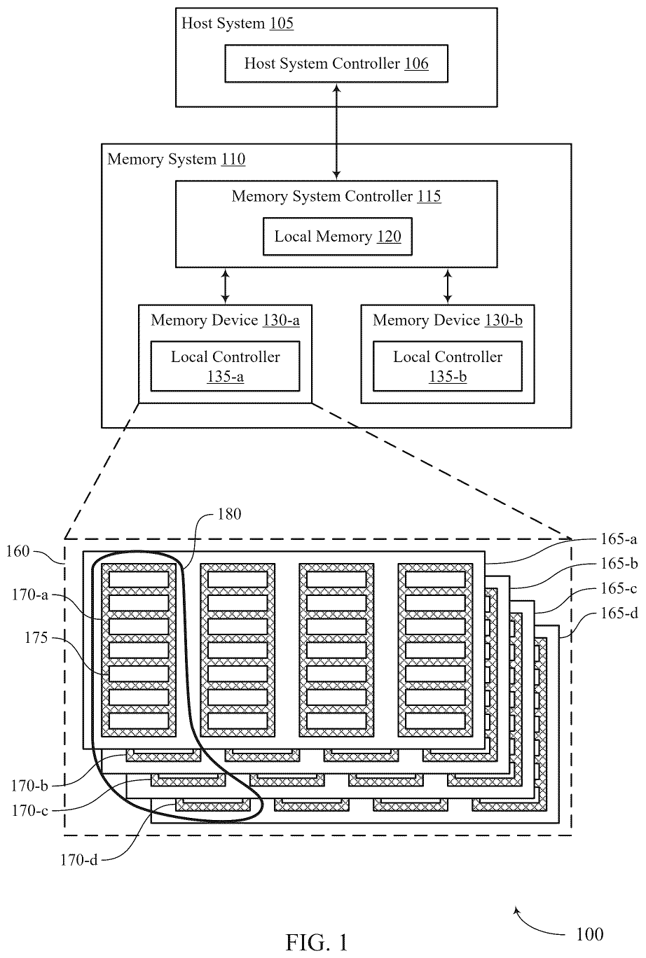

FIG. 1 shows an example of a system 100 that supports dynamic allocation of a host memory buffer in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices. In some cases, the memory system 110 may be implemented as part of an automotive system (e.g., as an automotive SSD). For example, the host system 105 may be an example of a host system on an automotive platform.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, the memory system 110 may have limited memory capacity for performing system operations (e.g., garbage collection, media management). For example, the memory system 110 may include a buffer, which may be used to temporarily store data during some types of operations, prior to writing the data to one or more memory devices, or transferring the data to the host system 105. In some cases, the buffer may reach capacity, and the memory system 110 may not be able to free up space in the buffer to continue performing operations. As such, the memory system may incur latencies for some operations if the memory system is unable to perform system operations (e.g., maintenance operations). In some cases, a portion of a memory of the host system 105 may be allocated as a buffer for use by the memory system 110. However, the size of the buffer may be inflexible, and may be unable to accommodate an increase in a frequency of system operations performed by the memory system 110 (e.g., in end-of-life scenarios, where more maintenance operations may be performed).

In accordance with examples as described herein, the host system 105 may allocate a portion of a memory of the host system 105 to a buffer for use by the memory system 110. In some cases, the allocation of the memory of the host system 105 may be based on a setting indicated by the memory system 110, which may indicate one or more parameters associated with the buffer. The memory system 110 may use the buffer for one or more operations, such as read, write, or system operations. In some examples, the host system 105 may indicate one or more resources available at the host system 105 for allocating to the buffer. The memory system 110 may communicate a second setting including one or more updated parameters associated with the buffer based on the indication of available resources, and the host system 105 may allocate one or more additional resources in response to the updated parameters. Accordingly, the memory system 110 and the host system 105 may adjust a size of the buffer, which may increase the memory availability of the memory system 110, and may result in reduced latencies.

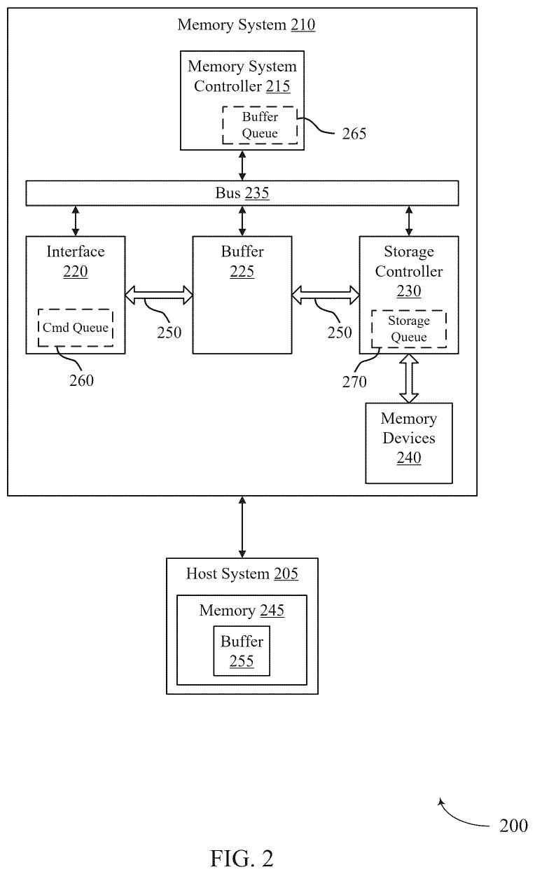

FIG. 2 shows an example of a system 200 that supports dynamic allocation of a host memory buffer in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples. In some cases, the memory system 210 may be implemented as part of an automotive system, and the memory system 210 may support capacities and temperatures associated with the automotive system.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In some cases, the memory system 210 may have limited memory capacity within buffer 225 for performing system operations (e.g., garbage collection, media management). When the buffer 225 reaches or approaches capacity, the memory system 210 may not be able to free up space in the buffer 225 to continue performing operations without substantial increases to latency. As such, the memory system may incur latencies for some operations if the memory system is unable to perform system operations (e.g., maintenance operations).

In accordance with examples as described herein, a portion of a memory 245 of the host system 205 may be allocated as a buffer 255 (e.g., a host memory buffer) for use by the memory system 210. In some examples, the allocation of the buffer 255 may be based on one or more settings indicated by the memory system 210. For example, the memory system 210 may indicate (e.g., via a command output by a controller, such as the memory system controller 215) a setting including one or more parameters associated with the buffer 255. In some examples, the one or more parameters may include a lower limit (e.g., a minimum) size for the buffer 255 (e.g., an HMMIN), which may indicate a smallest size for the buffer 255 that may be useable by the memory system 110. In some cases, the lower limit size for the buffer 225 may be indicated in units of kilobytes or a multiplier thereof (e.g., in 4 kilobyte units).

In some examples, the one or more parameters may include a requested (e.g., preferred) size for the buffer 255 (e.g., an HMPRE). The indication of the requested size for the buffer 255 may request the host system 205 to allocate a portion of the memory 245 to the buffer 255 corresponding to the requested size (e.g., if enough capacity is available). In some examples, the requested size may be greater than or equal to the lower limit size, and may be indicated in units of kilobytes or a multiplier thereof (e.g., in 4 kilobyte units). In some cases, if a lower limit size for the buffer 255 is not indicated by the memory system 110 (e.g., or indicated as a value of zero), the host system 205 may be indicated to allocate any amount of the memory 245 up to the requested size for the buffer 255. In some cases, the memory system 210 may indicate a value of zero for the requested size for the buffer 255 to indicate the host system 205 that the memory system 210 may not support using a buffer 255 from a portion of the memory 245. Alternatively, a non-zero value for the requested size may indicate the host system 205 that the memory system 210 supports usage of the buffer 255 of the host system 205.

In some examples, one or more contiguous portions of the memory 245 may be allocated as the buffer 255 by the host system 205, and each contiguous portion may correspond to a descriptor. For example, the host system 205 may indicate one or more descriptors, each descriptor corresponding to a (e.g., contiguous) portion of the memory 245, for the buffer 255 for use by the memory system 210. In some examples, the one or more parameters of the setting indicated by the memory system 210 may include a minimum quantity of descriptors for the buffer 255, a maximum quantity of descriptors for the buffer 255, or both. Additionally, or alternatively, the memory system 210 may indicate a value of zero for the minimum or maximum quantity of descriptors, which may indicate the host system 205 of no limitations on the lower or upper quantity of descriptors, respectively.

Accordingly, the memory system 210 may perform one or more operations based on the buffer 255. For example, the buffer 255 may be allocated for use by the memory system 210 (e.g., by a controller of the memory system 210, such as the memory system controller 215). The memory system 210 may receive one or more access commands (e.g., write commands, read commands) from the host system 205, and the memory system may output one or more commands (e.g., via the memory system controller 215) to the one or more memory devices 240 to perform the one or more operations in response to the one or more access commands. In some examples, the one or more operations may include accessing the buffer 255 for caching data. For example, the one or more operations may include writing first data to the one or more memory devices 240, reading second data from the one or more memory devices 240, or both, and the memory system 210 may store (e.g., cache) the first data, the second data, or both, at the buffer 255. Additionally, or alternatively, the memory system 210 may output read data (e.g., the second data) to the host system 205 via the buffer 255 (e.g., by writing the second data to the buffer 255). In some cases, the one or more parameters may include one or more maintenance operations for data stored to the one or more memory devices 240 of the memory system 210.

In some examples, the host system 205 may output a command indicating that additional resources of the memory 245 are available for the buffer 255. For example, the host system 205 may determine that one or more resources of the memory 245 are not in use, or have not been used over a threshold duration, and may output the command indicating the available resources in response. In some examples, the command may indicate one or more descriptors (e.g., as a descriptor list) corresponding to a set of addresses of the memory 245 available for the buffer 255.

In some cases, the host system 205 may output the command indicating the additional resources based on determining that a read latency, a write latency, or both, associated with the memory system 210 exceed a threshold value. In some examples, the command may be output if the read latency, write latency, or both, have exceeded the threshold value for at least a threshold duration. For example, the host system 205 may determine the read latency, the write latency, or both, based on one or more access operations performed by the host system 205 on the memory system 210. Additionally, or alternatively, the host system 205 may output the command indicating the additional resources based on determining a timeout associated with one or more commands issued to the memory system 210 (e.g., corresponding to the one or more access operations). For example, the host system 205 may determine that a quantity of command timeouts exceeds a threshold value, and the host system 205 may output the command indicating the additional resources of the memory 245 in response.

In some examples, the indication of the available resources of the memory 245 for the buffer 255 may be or include one or more recommended (e.g., updated) parameters associated with the buffer 255. For example, the host system 205 may indicate a recommended value for the requested size of the buffer 255 (e.g., HMPRE) via one or more bits of a word of a command, which may have a format as shown in Table 1. Additionally, or alternatively, one or more recommended parameters for the buffer 255 may be indicated via a data pointer (e.g., DPTR) portion of a command, as shown in Table 1. For example, the data pointer may indicate a portion of the memory 245 that may indicate the one or more parameters to the memory system 210. In some cases, the recommended value for the requested size of the buffer 255 may be used if a control table associated with the memory device (e.g., a Performance QoS table) indicates that buffer (e.g., host memory buffer) extension is enabled for the memory system 210.

TABLE 1
Command format

| Word Offset | Bits | Definition | Function |
|---|---|---|---|
| 0 | 31:16 | Command Identifier | May be set as defined in NVMe |
| | | (CID) | Specification version 2.0a. |
| | 15:14 | PRP or SGL for Data | May be set to zero |
| | | Transfer (PSDT) | |
| | 13:10 | Reserved | May be set to zero |
| | 9:8 | Fused Operation | May be set to zero |
| | | (FUSE) | |
| | 7:0 | Opcode (OPC) | May be set to 09h |
| | | | (OPC Set features = 09h, Get features = 0Ah) |
| 1 | 31:0 | Namespace Identifier | May be set to zero |
| | | (NSID) | |
| 3:2 | 31:0 | Reserved | May be set to zero |
| 5:4 | 31:0 | Metadata Pointer | May be set to zero |
| | | (MPTR) | |
| 9:6 | 31:0 | Data Pointer (DPTR) | May point to the physical contiguous 4KB |
| | | | aligned address. |
| 10 | 31 | Save (SV) | May be set to zero |
| | 30:8 | Reserved | May be set to zero |
| | 7:0 | Feature Identifier | May be set to 0xE10h |
| | | (FID) | |
| 11 | 31:16 | Reserved | May be set to zero |
| 11 | 15:0 | HMB buffer extension | See Performance QoS control format below: |
| | | control | |
| 12 | 31:0 | VS specific | Not Used. |
| 13 | 31:0 | VS specific | Not Used. |
| 14 | 31:07 | Reserved | |
| 14 | 06:00 | UUID Index: | |
| 15 | 31:0 | HMPRE INFO | Indicates HMPRE value recommended by |
| | | | host based on determined latency and |
| | | | available host memory. |

In some cases, the command may also include, using at least one bit, a do-not-retry indication. For example, if set to a first value (e.g., 1), the command may indicate that if the command fails, and is re-submitted, the command is expected to fail again. If set to a second value (e.g., 0), the command may indicate the command may succeed if re-submitted. As such, the command may indicate whether the command should be re-tried if failed. Additionally, or alternatively, the command may include an indication of whether additional status information for the command is available as part of an error information log, which may be obtained using a Get Log Page command (e.g., output by the host system 205). Additionally, or alternatively, the command may include a status code type, which may indicate whether a command specified by the Command and Submission Queue has completed. The command may also include a status code, which may indicate error information or status information for the indicated command (e.g., whether the command completed successfully, whether the command failed).

In some examples, the memory system 210 may output a second setting indicating one or more updated parameters for the buffer 255. For example, the second setting may be based on the one or more operations performed by the memory system 210, such as if the memory system 210 experienced a high latency (e.g., above a threshold) or determined that additional buffer capacity may be used for one or more additional operations. Additionally, or alternatively, the one or more updated parameters may be based on the indication of the additional memory resources available for the buffer 255 output by the host system 205.

In some examples, the one or more updated parameters may include an updated requested size for the buffer 255. The updated requested size may be based on the available resources of the memory 245 indicated by the host system 205. For example, the memory system 210 may request at least a portion of the available resources indicated by the host system 205 by increasing the requested size for the buffer 255 (e.g., relative to the first setting). Additionally, or alternatively, the one or more updated parameters may include an updated minimum or maximum quantity of identifiers, an updated lower limit for the size of the buffer 255, or a combination thereof.

In some cases, the host system 205 may indicate the one or more descriptors (e.g., the descriptor list) via the data pointer portion of the command, which may indicate a fragmentation level of the available resources for the buffer 255 to the memory system 210. The one or more parameters may be based on the fragmentation level. For example, the memory system 210 (e.g., via a controller thereof) may determine that the fragmentation level is relatively high (e.g., above a threshold), and may request (e.g., via the one or more updated parameters) additional resources for the buffer 255 that are less than the available resources indicated by the host system 205. As such, the memory system 210 may reduce overhead associated with managing fragmented memory of the buffer 255.

Accordingly, the allocation of memory 245 of the host system 205 to the buffer 255 may be dynamically adjusted based on latencies and the availability of resources, which may improve the utilization of resources of the system 200 and increase a bandwidth of the memory system 210. Additionally, the examples described herein enable the memory system 210 to indicate one or more limitations for the buffer 255 via the one or more parameters, thereby supporting different configurations of memory systems 210 (e.g., of the memory system controller 215). For example, some memory systems 210 may not support more complex memory layouts (e.g., of the host system 205) or quality of service requirements, and thus indications of limitations by the memory system 210 to the host system 205 may allow the host system 205 to adjust the buffer 255 accordingly. In addition, the host system 205 may adjust the buffer 255 to maintain high performance, such as for automotive systems, even with a relatively high logical saturation (e.g., relatively high quantity of logical addresses being used).

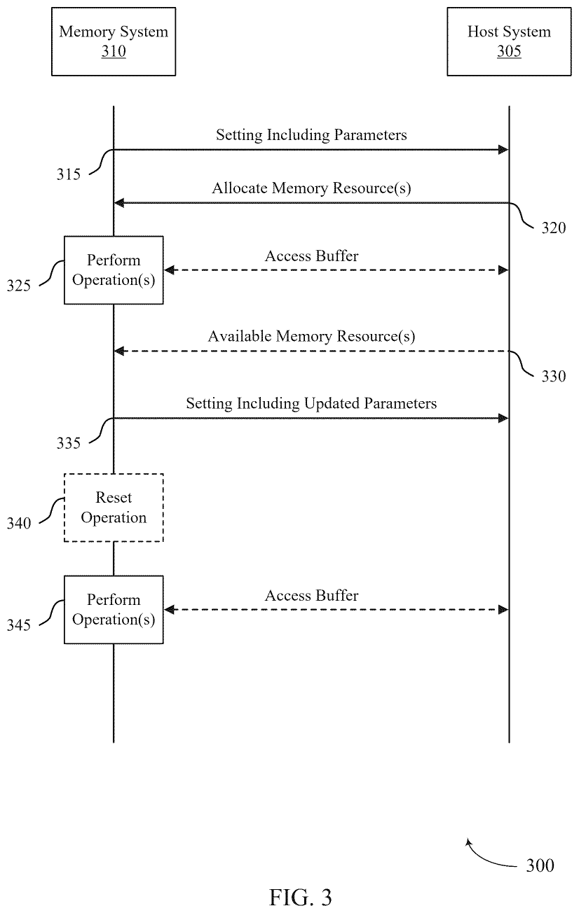

FIG. 3 shows an example of a process flow 300 that supports dynamic allocation of a host memory buffer in accordance with examples as disclosed herein. The process flow 300 may implement aspects of the system 100 and the system 200. For example, the memory system 310 may be an example of the memory system 210 and the memory system 110 and the host system 305 may be an example of the host system 105 and the host system 205, as described with reference to FIGS. 1 and 2.

At 315, the memory system 310 may output a first setting indicating one or more parameters associated with a buffer within memory of the host system 305, the buffer allocated for use by the memory system 310. In some examples, the one or more parameters may include a requested size for the buffer. In some cases, the requested size may include a minimum quantity of descriptors for the buffer, a maximum quantity of descriptors for the buffer, a size of each descriptor for the buffer, a preferred size of the buffer, or a combination thereof.

At 320, the host system 305 may output a first command indicating one or more memory resources within the memory of the host system 305 allocated for the buffer in accordance with the one or more parameters.

At 325, the memory system 310 may perform one or more operations. The one or more operations may include writing first data to memory of the memory system 310 (e.g., to one or more memory devices of the memory system 310), reading second data from the memory of the memory system, or both. In some examples, the one or more operations may be performed in response to receiving one or more access commands (not shown) from the host system 305. In some cases, the memory system 310 may access the buffer in the memory of the host system 305 as part of the one or more operations. For example, the one or more operations may include accessing the buffer within the memory of the host system for caching the first data, the second data, or both. In some examples, the one or more operations may include one or more maintenance operations for data stored at the memory of the memory system 310.

At 330, the host system 305 may output a second command indicating that additional memory resources of the host system 305 are available for the buffer. For example, the second command may indicate one or more descriptors corresponding to one or more portions of the memory of the host system 305. In some examples, the host system 305 may determine (e.g., based on the one or more access operations) that a read latency, a write latency, or both, associated with the memory system 310 exceeds a threshold value (e.g., associated with quality of service requirements, such as for an automotive system), and the indication of the availability of the additional memory resources may be outputted based at on the determination of the read latency, the write latency, or both, exceeding the threshold value. In some cases, the indication of the availability of the additional memory resources may be outputted in response to the read latency, the write latency, or both, exceeding a threshold value for at least a threshold duration. Additionally, or alternatively, the host system 305 may determine one or more timeouts associated with one or more commands associated with performing the one or more access operations, and outputting the indication of the availability of the additional memory resources may be in response to the determination of the one or more timeouts.

At 335, the memory system 310 may output a second setting indicating one or more updated parameters for the buffer. The one or more updated parameters may be based on performing the one or more operations, on the indication of the available memory resources, or both. In some examples, the one or more updated parameters may include an updated requested size for the buffer based on the indication of the availability of the additional memory resources received from the host system 305. For example, the updated requested size may be an increase in the requested size relative to that of the first setting based on the indication of the availability of the additional memory resources for the buffer.

At 340, the memory system 310 may perform a reset operation. In some cases, the resources of the memory of the host system 305 allocated by the host system 305 to the buffer may not persist following a reset operation by the memory system 310 (e.g., initiated by the memory system 310 or the host system 305). In some examples, the host system 305 may provide (e.g., re-allocate) the previously allocated memory resources of the host system 305 after the reset operation at 340 to maintain the resources allocated to the buffer.

At 345, the memory system 310 may perform one or more additional operations. The one or more additional operations may include accessing the buffer, such as for caching data associated with access commands or maintenance operations. The one or more additional operations may be performed in accordance with an increased size of the buffer based on the indication of the one or more updated parameters.

Accordingly, a bandwidth of the memory system 310 may be increased and dynamically adjusted by allocating resources of the host system 305 according to one or more parameters and the available resources of the host system 305. As such, the memory system 310 may utilize the increased bandwidth for additional caching capacity or for performing one or more maintenance operations, thereby reducing latencies for access operations even in high logical saturation scenarios, which may improve performance within automotive systems, for example.

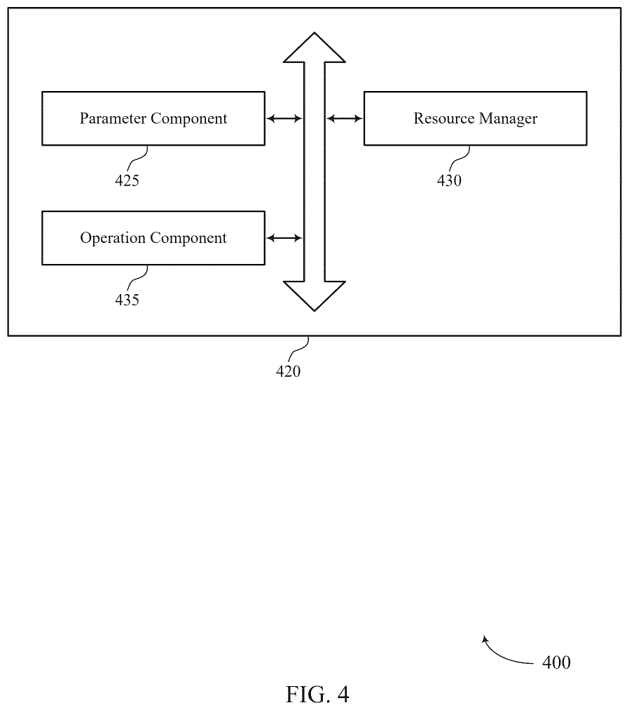

FIG. 4 shows a block diagram 400 of a memory system 420 that supports dynamic allocation of a host memory buffer in accordance with examples as disclosed herein. The memory system 420 may be an example of aspects of a memory system as described with reference to FIGS. 1 through 3. The memory system 420, or various components thereof, may be an example of means for performing various aspects of dynamic allocation of a host memory buffer as described herein. For example, the memory system 420 may include a parameter component 425, a resource manager 430, an operation component 435, or any combination thereof. Each of these components, or components of subcomponents thereof (e.g., one or more processors, one or more memories), may communicate, directly or indirectly, with one another (e.g., via one or more buses). In some examples, the memory system 420 may be implemented as part of an automotive system (e.g., an automotive SSD).

The parameter component 425 may be configured as or otherwise support a means for outputting, to a host system, a first setting indicating one or more parameters associated with a buffer within memory of the host system allocated for use by the memory system, the one or more parameters including a requested size for the buffer. The resource manager 430 may be configured as or otherwise support a means for receiving, from the host system, a first command indicating one or more memory resources within the memory of the host system allocated for the buffer in accordance with the one or more parameters. The operation component 435 may be configured as or otherwise support a means for performing one or more operations including writing first data to memory of the memory system, reading second data from the memory of the memory system, or both. In some examples, the parameter component 425 may be configured as or otherwise support a means for outputting, to the host system, a second setting indicating one or more updated parameters for the buffer based at least in part on performing the one or more operations.

In some examples, the resource manager 430 may be configured as or otherwise support a means for receiving, from the host system, a second command indicating that additional memory resources are available for the buffer, where outputting the second setting is in response to the indication that the additional memory resources are available.

In some examples, the one or more updated parameters includes an updated requested size for the buffer based at least in part on receiving the indication of the availability of the additional memory resources.

In some examples, the one or more operations are performed in response to receiving one or more access commands from the host system. In some examples, accessing the buffer within the memory of the host system for caching the first data, the second data, or both.

In some examples, the one or more operations include one or more maintenance operations for data stored to the memory of the memory system. In some examples, the requested size includes a minimum quantity of descriptors for the buffer, a maximum quantity of descriptors for the buffer, a size of each descriptor for the buffer, a preferred size of the buffer, or a combination thereof. In some examples, the second setting indicates an updated requested size for the buffer.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

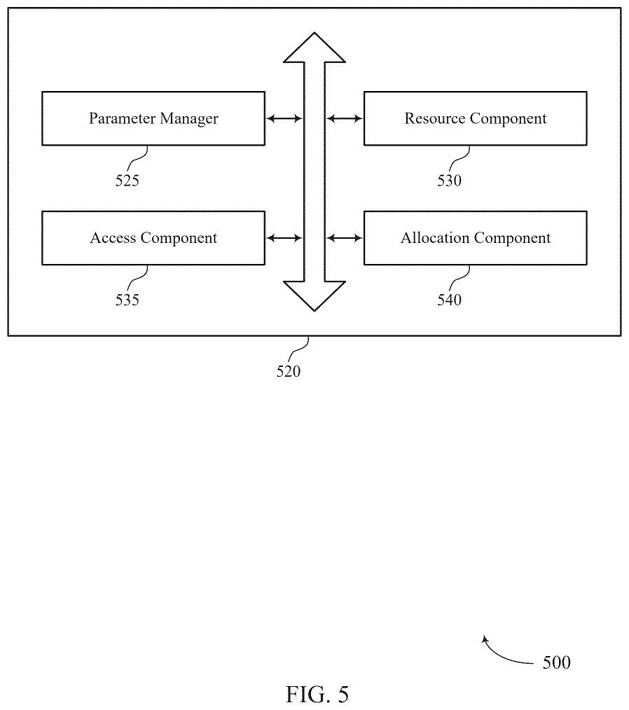

FIG. 5 shows a block diagram 500 of a host system 520 that supports dynamic allocation of a host memory buffer in accordance with examples as disclosed herein. The host system 520 may be an example of aspects of a host system as described with reference to FIGS. 1 through 3. The host system 520, or various components thereof, may be an example of means for performing various aspects of dynamic allocation of a host memory buffer as described herein. For example, the host system 520 may include a parameter manager 525, a resource component 530, an access component 535, an allocation component 540, or any combination thereof. Each of these components, or components of subcomponents thereof (e.g., one or more processors, one or more memories), may communicate, directly or indirectly, with one another (e.g., via one or more buses).

The parameter manager 525 may be configured as or otherwise support a means for receiving, from a memory system, a first setting indicating one or more parameters associated with a buffer within memory of the host system allocated for use by the memory system, the one or more parameters including a requested size for the buffer. The resource component 530 may be configured as or otherwise support a means for outputting a first command indicating one or more memory resources within the memory of the host system allocated for the buffer. The access component 535 may be configured as or otherwise support a means for performing one or more access operations with the memory system, the one or more access operations including writing first data to the memory system, reading second data from the memory system, or both. In some examples, the parameter manager 525 may be configured as or otherwise support a means for receiving a second setting indicating one or more updated parameters for the buffer. The allocation component 540 may be configured as or otherwise support a means for allocating additional memory resources within the memory of the host system for the buffer.

In some examples, the resource component 530 may be configured as or otherwise support a means for outputting, to the memory system, a second command indicating that the additional memory resources are available for the buffer.

In some examples, the resource component 530 may be configured as or otherwise support a means for determining, based at least in part on performing the one or more access operations, that a read latency, a write latency, or both, associated with the memory system exceeds a threshold value, where the indication of the availability of the additional memory resources is outputted based at least in part on the determination of the read latency, the write latency, or both, exceeding the threshold value.

In some examples, the indication of the availability of the additional memory resources is outputted based at least in part on determining that the read latency, the write latency, or both, exceed the threshold value for at least a threshold duration. In some examples, the threshold value may be associated with one or more parameters (e.g., quality of service requirements, thresholds) of an automotive system.

In some examples, the resource component 530 may be configured as or otherwise support a means for determining a timeout associated with one or more commands associated with performing the one or more access operations, where outputting the indication of the availability of the additional memory resources is based at least in part on the determination of the timeout.

In some examples, the one or more updated parameters include an updated requested size for the buffer that includes an increase from a size of the buffer indicated in the first command. In some examples, the requested size includes a minimum quantity of descriptors for the buffer, a maximum quantity of descriptors for the buffer, a size of each descriptor for the buffer, a preferred size of the buffer, or a combination thereof.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

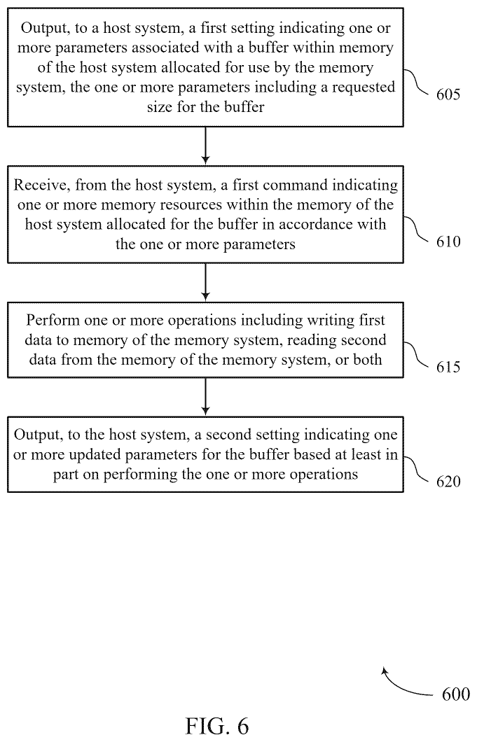

FIG. 6 shows a flowchart illustrating a method 600 that supports dynamic allocation of a host memory buffer in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include outputting, to a host system, a first setting indicating one or more parameters associated with a buffer within memory of the host system allocated for use by the memory system, the one or more parameters including a requested size for the buffer. In some examples, aspects of the operations of 605 may be performed by a parameter component 425 as described with reference to FIG. 4.

At 610, the method may include receiving, from the host system, a first command indicating one or more memory resources within the memory of the host system allocated for the buffer in accordance with the one or more parameters. In some examples, aspects of the operations of 610 may be performed by a resource manager 430 as described with reference to FIG. 4.

At 615, the method may include performing one or more operations including writing first data to memory of the memory system, reading second data from the memory of the memory system, or both. In some examples, aspects of the operations of 615 may be performed by an operation component 435 as described with reference to FIG. 4.

At 620, the method may include outputting, to the host system, a second setting indicating one or more updated parameters for the buffer based at least in part on performing the one or more operations. In some examples, aspects of the operations of 620 may be performed by a parameter component 425 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for outputting, to a host system, a first setting indicating one or more parameters associated with a buffer within memory of the host system allocated for use by the memory system, the one or more parameters including a requested size for the buffer; receiving, from the host system, a first command indicating one or more memory resources within the memory of the host system allocated for the buffer in accordance with the one or more parameters; performing one or more operations including writing first data to memory of the memory system, reading second data from the memory of the memory system, or both; and outputting, to the host system, a second setting indicating one or more updated parameters for the buffer based at least in part on performing the one or more operations.
Aspect 2: The method, apparatus, or non-transitory computer-readable medium of aspect 1, further including operations, features, circuitry, logic, means, or instructions, or any combination thereof for receiving, from the host system, a second command indicating that additional memory resources are available for the buffer, where outputting the second setting is in response to the indication that the additional memory resources are available.
Aspect 3: The method, apparatus, or non-transitory computer-readable medium of aspect 2, where the one or more updated parameters includes an updated requested size for the buffer based at least in part on receiving the indication of the availability of the additional memory resources.
Aspect 4: The method, apparatus, or non-transitory computer-readable medium of any of aspects 1 through 3, where the one or more operations are performed in response to receiving one or more access commands from the host system.
Aspect 5: The method, apparatus, or non-transitory computer-readable medium of any of aspects 1 through 4, where accessing the buffer within the memory of the host system for caching the first data, the second data, or both.
Aspect 6: The method, apparatus, or non-transitory computer-readable medium of any of aspects 1 through 5, where the one or more operations include one or more maintenance operations for data stored to the memory of the memory system.
Aspect 7: The method, apparatus, or non-transitory computer-readable medium of any of aspects 1 through 6, where the requested size includes a minimum quantity of descriptors for the buffer, a maximum quantity of descriptors for the buffer, a size of each descriptor for the buffer, a preferred size of the buffer, or a combination thereof.
Aspect 8: The method, apparatus, or non-transitory computer-readable medium of any of aspects 1 through 7, where the second setting indicates an updated requested size for the buffer.

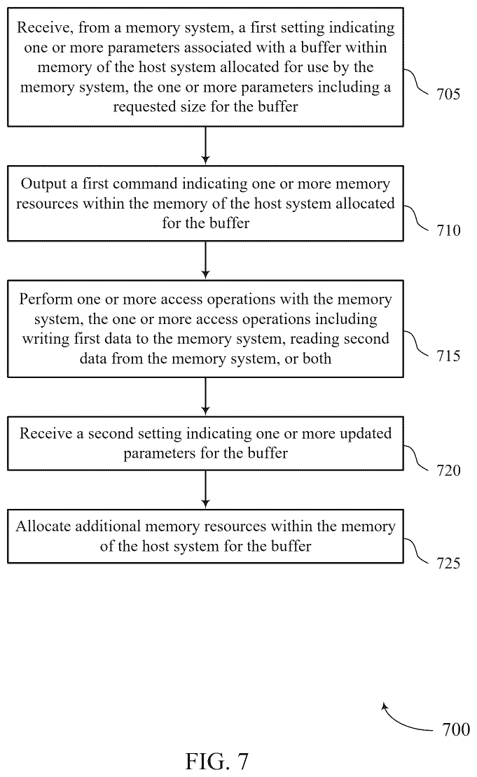

FIG. 7 shows a flowchart illustrating a method 700 that supports dynamic allocation of a host memory buffer in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include receiving, from a memory system, a first setting indicating one or more parameters associated with a buffer within memory of the host system allocated for use by the memory system, the one or more parameters including a requested size for the buffer. In some examples, aspects of the operations of 705 may be performed by a parameter manager 525 as described with reference to FIG. 5.

At 710, the method may include outputting a first command indicating one or more memory resources within the memory of the host system allocated for the buffer. In some examples, aspects of the operations of 710 may be performed by a resource component 530 as described with reference to FIG. 5.

At 715, the method may include performing one or more access operations with the memory system, the one or more access operations including writing first data to the memory system, reading second data from the memory system, or both. In some examples, aspects of the operations of 715 may be performed by an access component 535 as described with reference to FIG. 5.

At 720, the method may include receiving a second setting indicating one or more updated parameters for the buffer. In some examples, aspects of the operations of 720 may be performed by a parameter manager 525 as described with reference to FIG. 5.

At 725, the method may include allocating additional memory resources within the memory of the host system for the buffer. In some examples, aspects of the operations of 725 may be performed by an allocation component 540 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 9: A method, apparatus, or non-transitory computer-readable medium including operations, features, circuitry, logic, means, or instructions, or any combination thereof for receiving, from a memory system, a first setting indicating one or more parameters associated with a buffer within memory of the host system allocated for use by the memory system, the one or more parameters including a requested size for the buffer; outputting a first command indicating one or more memory resources within the memory of the host system allocated for the buffer; performing one or more access operations with the memory system, the one or more access operations including writing first data to the memory system, reading second data from the memory system, or both; receiving a second setting indicating one or more updated parameters for the buffer; and allocating additional memory resources within the memory of the host system for the buffer.
Aspect 10: The method, apparatus, or non-transitory computer-readable medium of aspect 9, further including operations, features, circuitry, logic, means, or instructions, or any combination thereof for outputting, to the memory system, a second command indicating that the additional memory resources are available for the buffer.
Aspect 11: The method, apparatus, or non-transitory computer-readable medium of aspect 10, further including operations, features, circuitry, logic, means, or instructions, or any combination thereof for determining, based at least in part on performing the one or more access operations, that a read latency, a write latency, or both, associated with the memory system exceeds a threshold value, where the indication of the availability of the additional memory resources is outputted based at least in part on the determination of the read latency, the write latency, or both, exceeding the threshold value.
Aspect 12: The method, apparatus, or non-transitory computer-readable medium of aspect 11, where the indication of the availability of the additional memory resources is outputted based at least in part on determining that the read latency, the write latency, or both, exceed the threshold value for at least a threshold duration. In some examples, the threshold value may be associated with one or more parameters (e.g., quality of service requirements, thresholds) of an automotive system.
Aspect 13: The method, apparatus, or non-transitory computer-readable medium of any of aspects 10 through 12, further including operations, features, circuitry, logic, means, or instructions, or any combination thereof for determining a timeout associated with one or more commands associated with performing the one or more access operations, where outputting the indication of the availability of the additional memory resources is based at least in part on the determination of the timeout.
Aspect 14: The method, apparatus, or non-transitory computer-readable medium of any of aspects 10 through 13, where the one or more updated parameters include an updated requested size for the buffer that includes an increase from a size of the buffer indicated in the first command.
Aspect 15: The method, apparatus, or non-transitory computer-readable medium of any of aspects 9 through 14, where the requested size includes a minimum quantity of descriptors for the buffer, a maximum quantity of descriptors for the buffer, a size of each descriptor for the buffer, a preferred size of the buffer, or a combination thereof.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
output, to a host system, a first setting indicating one or more parameters associated with a buffer within memory of the host system allocated for use by the memory system, the one or more parameters comprising a requested size for the buffer;
receive, from the host system, a first command indicating one or more memory resources within the memory of the host system allocated for the buffer in accordance with the one or more parameters;
perform one or more operations comprising writing first data to memory of the memory system, reading second data from the memory of the memory system, or both; and
output, to the host system, a second setting indicating one or more updated parameters for the buffer based at least in part on performing the one or more operations.

2. The memory system of claim 1, wherein the processing circuitry is further configured to cause the memory system to:
receive, from the host system, a second command indicating that additional memory resources are available for the buffer, wherein outputting the second setting is in response to the indication that the additional memory resources are available.

3. The memory system of claim 2, wherein the one or more updated parameters comprises an updated requested size for the buffer based at least in part on receiving the indication of the availability of the additional memory resources.

4. The memory system of claim 1, wherein the one or more operations are performed in response to receiving one or more access commands from the host system.

5. The memory system of claim 1, wherein the one or more operations comprise accessing the buffer within the memory of the host system for caching the first data, the second data, or both.

6. The memory system of claim 1, wherein the one or more operations comprise one or more maintenance operations for data stored to the memory of the memory system.

7. The memory system of claim 1, wherein the requested size comprises a minimum quantity of descriptors for the buffer, a maximum quantity of descriptors for the buffer, a size of each descriptor for the buffer, a preferred size of the buffer, or a combination thereof.

8. The memory system of claim 1, wherein the second setting indicates an updated requested size for the buffer.

9. A host system, comprising:
one or more interfaces comprising one or more signal paths operable for communications with one or more memory systems; and
processing circuitry coupled with the one or more interfaces and configured to cause the host system to:
receive, from a memory system, a first setting indicating one or more parameters associated with a buffer within memory of the host system allocated for use by the memory system, the one or more parameters comprising a requested size for the buffer;
output a first command indicating one or more memory resources within the memory of the host system allocated for the buffer;
perform one or more access operations with the memory system, the one or more access operations comprising writing first data to the memory system, reading second data from the memory system, or both;
receive a second setting indicating one or more updated parameters for the buffer; and
allocate additional memory resources within the memory of the host system for the buffer.

10. The host system of claim 9, wherein the processing circuitry is further configured to cause the host system to:
output, to the memory system, a second command indicating that the additional memory resources are available for the buffer.

11. The host system of claim 10, wherein the processing circuitry is further configured to cause the host system to:
determine, based at least in part on performing the one or more access operations, that a read latency, a write latency, or both, associated with the memory system exceeds a threshold value, wherein the indication of the availability of the additional memory resources is outputted based at least in part on the determination of the read latency, the write latency, or both, exceeding the threshold value.

12. The host system of claim 11, wherein the indication of the availability of the additional memory resources is outputted based at least in part on determining that the read latency, the write latency, or both, exceed the threshold value for at least a threshold duration.

13. The host system of claim 11, wherein the threshold value is associated with one or more parameters of an automotive system.

14. The host system of claim 10, wherein the processing circuitry is further configured to cause the host system to:
determine a timeout associated with one or more commands associated with performing the one or more access operations, wherein outputting the indication of the availability of the additional memory resources is based at least in part on the determination of the timeout.

15. The host system of claim 10, wherein the one or more updated parameters comprise an updated requested size for the buffer that comprises an increase from a size of the buffer indicated in the first command.

16. The host system of claim 9, wherein the requested size comprises a minimum quantity of descriptors for the buffer, a maximum quantity of descriptors for the buffer, a size of each descriptor for the buffer, a preferred size of the buffer, or a combination thereof.

17. A method by a memory system, comprising:
outputting, to a host system, a first setting indicating one or more parameters associated with a buffer within memory of the host system allocated for use by the memory system, the one or more parameters comprising a requested size for the buffer;
receiving, from the host system, a first command indicating one or more memory resources within the memory of the host system allocated for the buffer in accordance with the one or more parameters;
performing one or more operations comprising writing first data to memory of the memory system, reading second data from the memory of the memory system, or both; and
outputting, to the host system, a second setting indicating one or more updated parameters for the buffer based at least in part on performing the one or more operations.

18. The method of claim 17, further comprising:
receiving, from the host system, a second command indicating that additional memory resources are available for the buffer, wherein outputting the second setting is in response to the indication that the additional memory resources are available.

19. The method of claim 18, wherein the one or more updated parameters comprises an updated requested size for the buffer based at least in part on receiving the indication of the availability of the additional memory resources.

20. The method of claim 17, wherein the one or more operations are performed in response to receiving one or more access commands from the host system.

21. The method of claim 17, wherein the one or more operations comprise accessing the buffer within the memory of the host system for caching the first data, the second data, or both.

22. The method of claim 17, wherein the one or more operations comprise one or more maintenance operations for data stored to the memory of the memory system.

23. The method of claim 17, wherein the requested size comprises a minimum quantity of descriptors for the buffer, a maximum quantity of descriptors for the buffer, a size of each descriptor for the buffer, a preferred size of the buffer, or a combination thereof.
